(19) United States
(12) Patent Application Publication
(10) Pub. No.: US 2018/0236976 A1
(43) Pub. Date: Aug. 23, 2018

(54) RAIN SENSOR

(71) Applicant: DENSO CORPORATION, Kariya-city (JP)

(72) Inventor: Ayana SHIMAZAKI, Kariya-city (JP)

(73) Assignee: DENSO CORPORATION, Kariya-city (JP)

(21) Appl. No.: 15/897,200

(22) Filed: Feb. 15, 2018

(30) Foreign Application Priority Data
Feb. 22, 2017 (JP) 2017-31331

(51) Int. Cl. B60S 1/08; G01V 8/14; G01J 1/44; G01J 1/04

(52) U.S. Cl. CPC B60S 1/0837; G01V 8/14; B60S 1/0892; G01J 1/0411; G01J 1/44

(57) ABSTRACT

A lens receives light from an emitting element and guides the light reflected on an outer surface of a windshield toward a receiving element. Arithmetic processing is to acquire, as a sensor output signal, a difference between a light receiving value of the receiving element before or after an emission timing of pulsed light and a light receiving value at the emission timing. Comparison processing is to determine that the present value is normal and to use the present value as the sensor output signal when a difference between a previous value and a present value of the sensor output signal is less than a threshold. The comparison processing is to determine that the present value is abnormal and not to use the present value for controlling a wiper device when the difference is greater than or equal to the abnormality threshold.

### CROSS REFERENCE TO RELATED APPLICATION

This application is based on Japanese Patent Application No. 2017-31331 filed on Feb. 22, 2017, the disclosure of which is incorporated herein by reference.

### TECHNICAL FIELD

The present disclosure relates to a rain sensor configured to send a signal to control an operation of a vehicular wiper.

### BACKGROUND

Patent Literature 1 proposes an example of a rain sensor that generates a signal to control a vehicular wiper device. The rain sensor acquires an obstacle light signal, which represents a circumference light, according to a sensor signal acquired by not emitting a transmitter beam for water drop detection at a first interval. Subsequently, the rain sensor acquires a sensor signal including the circumference light and the transmitter beam by emitting the transmitter beam at a second interval.

Subsequently, the rain sensor retrieves a difference between the sensor signals obtained at the first and second intervals, respectively, thereby to offset a component of the circumference light. In this way, the rain sensor acquires an effective light signal substantially corresponding to the transmitter beam. Thus, the rain sensor evaluates the effective light signal thereby to determine whether to activate the wiper operation.

(Patent Literature 1)

Publication of International Application No. 2001-516669

The above-described configuration of the rain sensor may effectively determine the activation of the wiper operation in a state where the component of the circumference light is substantially constant at the first and second intervals. Nevertheless, in a state where momentary light, such as flash of a camera, is incident for a significantly short time period, the component of the circumference light, which forms a base signal of the light signal, may vary between the first and second intervals. In such a state, the rain sensor may not be able to selectively detect the component of the transmitter beam. Consequently, fluctuation may occur in the effective light signal. As a result, the rain sensor may determine the fluctuation, which is caused by the momentary light, to be a fluctuation caused by raindrop adhesion. In response, the rain sensor may cause a false operation of a wiper.

### SUMMARY

It is an object of the present disclosure to produce a rain sensor configured to restrict a wiper from performing a false operation in a case where momentary light is incident in a short time period.

According to an aspect of the present disclosure, a rain sensor comprises a light emitting element configured to be located on a side of an inner surface of a windshield of a vehicle and to emit light toward the inner surface. The rain sensor further comprises a light receiving element configured to be located on the side of the inner surface and to receive light reflected on an outer surface of the windshield. The rain sensor further comprises a lens configured to guide light, which is emitted from the light emitting element, to its inside while collimating the light into parallel light, to conduct the collimated light to the outer surface, and to guide the light, which is reflected on the outer surface, toward the light receiving element. The rain sensor further comprises a processing unit. The processing unit is configured to execute light emission processing to cause the light emitting element to serially emit pulsed light. The processing unit is further configured to execute arithmetic processing to acquire, as a sensor output signal for the pulsed light, a difference between a light receiving value of the light receiving element, which is before or after a light emission time point of the pulsed light, and a light receiving value of the light receiving element at the light emission time point of the pulsed light. The processing unit is further configured to execute abnormality determination processing to determine whether an abnormality arises in the sensor output signal. The processing unit is further configured to execute control processing to control an operation of a wiper device of the vehicle according to the sensor output signal processed with the abnormality determination processing. The processing unit is further configured to execute, in the abnormality determination processing, comparison processing. The comparison processing is to acquire a difference value between a previous value of the sensor output signal and a present value of the sensor output signal. The comparison processing is further to determine that the present value is a normal value and to use the present value as the sensor output signal when the difference value is less than an abnormality threshold. The comparison processing is further to determine that the present value is an abnormality value and not to use the present value for the control processing when the difference value is greater than or equal to the abnormality threshold.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view showing a rain sensor according to a first embodiment of the present disclosure;

FIG. 2 is a timechart showing an averaged sensor output signals for wiper control;

FIG. 3 is a flowchart showing contents of abnormality determination processing;

FIG. 4 is a timechart showing an example to remove a component of circumference light from a light receiving value of a light receiving element;

FIG. 5 is a timechart showing an example in which a component of circumference light is not removed from a light receiving value of the light receiving element; and

FIG. 6 is a timechart showing another example in which a component of circumference light is not removed from a light receiving value of the light receiving element.

### DETAILED DESCRIPTION

As follows, embodiments of the present disclosure will be described with reference to drawings. In the following embodiments, the same elements or equivalent elements will be denoted with the same reference numeral.

### First Embodiment

As follows, the first embodiment of the present disclosure will be described with reference to drawings. A rain sensor according to the present embodiment is configured to detect a raindrop, which adheres on a vehicular windshield, and to manipulate a wiper device according to a result of the detection.

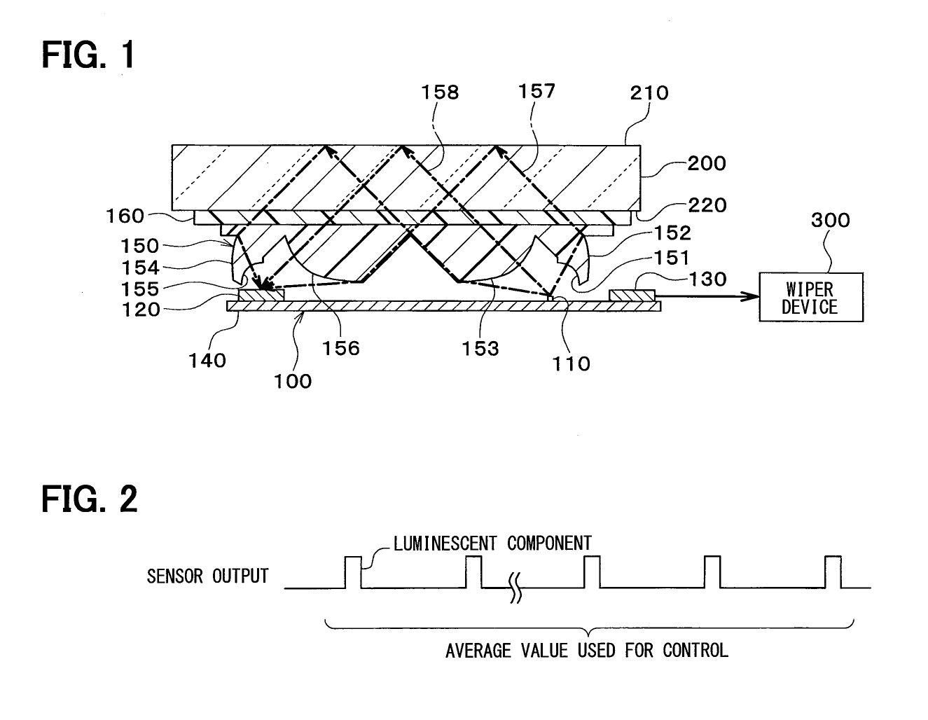

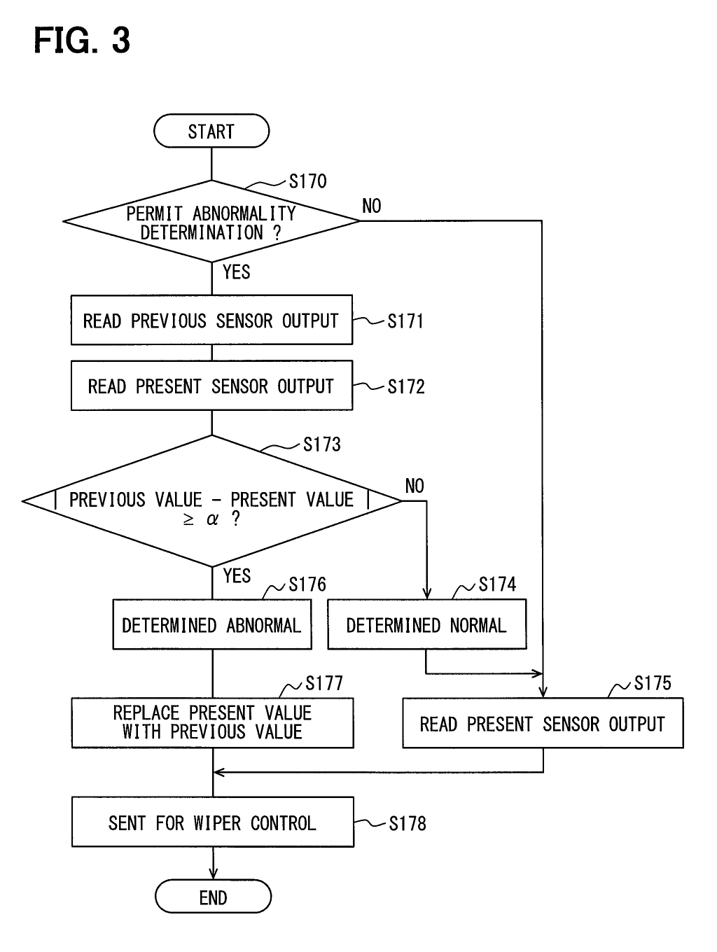

As shown in FIG. 1, a rain sensor 100 is configured to include a light emitting element 110, a light receiving element 120, a processing unit 130, a circuit board 140, and a lens 150.

The light emitting element 110 is a projection device to project a measurement light for detecting a raindrop adhering on an outer surface 210 of a vehicular windshield 200. The light emitting element 110 is located on the side of an inner surface 220 of the windshield 200 and is configured to emit light toward the inner surface 220. The light emitting element 110 is configured as a light emitting diode (LED) to emit light onto the windshield 200. The light emitting element 110 is configured with, for example, a semiconductor chip. It is noted that, the outer surface 210 of the windshield 200 is a surface outside the vehicle, and the inner surface 220 of the windshield 200 is a surface inside the vehicle.

The light receiving element 120 is a photoreceiver device configured to receive light emitted from the light emitting element 110. The light receiving element 120 is located on the side of the inner surface 220 of the windshield 200 and is configured to receive the light, which is emitted from the light emitting element 110 and reflected on the outer surface 210 of the windshield 200. The light receiving element 120 is configured as a photo-diode (PD), which is to detect a light intensity of the received light. The light receiving element 120 is configured with, for example, a semiconductor chip.

The processing unit 130 is a control circuit equipped with a CPU, a ROM, a RAM and/or the like (not shown) and configured to perform signal processing in line with a program stored in the ROM and/or the like. The processing unit 130 is configured with, for example, a microcomputer. The processing unit 130 executes processing to drive the light emitting element 110 and to process a detection result of the light receiving element 120. The processing unit 130 further manipulates the vehicular wiper device 300 according to a result of the processing.

The wiper device 300 is a device to drive and control a wiper. The wiper device 300 is configured with, for example, an electronic control unit (ECU). The wiper device 300 includes a microcomputer, a wiper motor control circuit, and a wiper motor actuator. The wiper device 300 is activated with a power supply from a vehicular battery.

The circuit board 140 is mounted with electronic components, such as the light emitting element 110, the light receiving element 120, the processing unit 130, a connector (not shown), and/or the like. The circuit board 140 is, for example, a printed circuit board. The light receiving element 120 is mounted on the circuit board 140 and is at a predetermined distance from the light emitting element 110.

The lens 150 is an optical component configured to pass the light, which is emitted from the light emitting element 110, therethrough and to collimate the light into parallel light. The lens 150 is to conduct the collimated light toward the outer surface 210 and to guide the light, which is reflected on the outer surface 210, toward the light receiving element 120. The lens 150 is formed of a material, such as glass, polycarbonate, or acrylic resin. As shown in FIG. 1, the lens 150 has an incidence side recessed surface 151, an incidence side reflective surface 152, an incidence side lens surface 153, an outgoing side reflective surface 154, an outgoing side recessed surface 155, and an outgoing side lens surface 156.

The incidence side recessed surface 151 is an incidence surface to guide light, which is emitted from the light emitting element 110 to the opposite side of the light receiving element 120, toward the inside of the lens 150 while maintaining the straightness of the light. The terms of “while maintaining the straightness of the light” represents a function of the incidence side recessed surface 151 not to cause the light to be refracted. The incidence side recessed surface 151 is in a shape dented in a direction away from the light emitting element 110. The incidence side recessed surface 151 is, for example, in a spherical shape or in an aspherical shape.

The incidence side reflective surface 152 is a reflective surface to reflect light, which is incident into the lens 150 through the incidence side recessed surface 151. The incidence side reflective surface 152 collimates the reflected light to become parallel light and conducts the collimated parallel light toward the outer surface 210 of the windshield 200. The incidence side reflective surface 152 is mirror-finished and is in a shape to totally reflect the collimated parallel light.

The incidence side lens surface 153 is a lens surface to guide the light, which is emitted from the light emitting element 110 on the opposite side of the incidence side recessed surface 151 toward the light receiving element 120, into the lens 150. The incidence side lens surface 153 collimates the light, which is incident into the lens 150, to become parallel light and conducts the collimated parallel light toward the outer surface 210 of the windshield 200.

The outgoing side reflective surface 154 is a reflective surface to reflect light, which is reflected on the outer surface 210 of the windshield 200 to pass toward the light receiving element 120 beyond the outgoing side lens surface 156, toward the light receiving element 120. The outgoing side reflective surface 154 is mirror-finished and is in a shape to totally reflect the light.

The outgoing side recessed surface 155 is a lens surface to conduct light, which is reflected on the outgoing side reflective surface 154, toward the light receiving element 120 while maintaining the straightness of the light. The outgoing side recessed surface 155 is in a shape dented in a direction away from the light receiving element 120. Similarly to the incidence side recessed surface 151, the outgoing side recessed surface 155 is in a shape not to refract light.

The outgoing side lens surface 156 is a lens surface to conduct light, which is reflected on the outer surface 210 of the windshield 200, toward the light receiving element 120. The outgoing side lens surface 156 is located between the incidence side lens surface 153 and the light receiving element 120.

The rain sensor 100 according to the present embodiment configuration has the configuration as described above. The circuit board 140, on which the light emitting element 110, the light receiving element 120, the processing unit 130, and the like, are mounted, and the lens 150 are accommodated in a cover housing (not shown) and are packaged into an integrated device. The lens 150 is exposed from the cover housing.

Referring to FIG. 1, the lens 150 is biased onto a sheet 160. The sheet 160 is a member interposed between the rain sensor 100 and the windshield 200. The sheet 160 is, for example, a silicone sheet. The measurement light passing through the lens 150 is incident into the windshield 200 through the sheet 160.

Subsequently, optical paths of the measurement light inside the lens 150 will be described. As shown in FIG. 1, measurement light emitted from the light emitting element 110 is received with the light receiving element 120 after passing along a first optical path 157 and a second optical path 158.

The measurement light, which is emitted from the light emitting element 110 on the opposite side of the light receiving element 120, passes along the first optical path 157. Specifically, the measurement light passes through the incidence side recessed surface 151 and enters the inside of the lens 150. The measurement light is reflected and collimated on the incidence side reflective surface 152 and is guided toward the outer surface 210 of the windshield 200. The measurement light on the first optical path 157 from the outer surface 210 of the windshield 200 further passes through the outgoing side lens surface 156. The measurement light is focused toward the light receiving element 120.

In addition, the measurement light, which is emitted from the light emitting element 110 toward the light receiving element 120, passes along the second optical path 158. Specifically, the measurement light passes through the incidence side lens surface 153 and enters the inside of the lens 150. The measurement light is reflected and collimated on the incidence side lens surface 153 and is guided toward the outer surface 210 of the windshield 200. The measurement light on the second optical path 158 from the outer surface 210 of the windshield 200 further passes through the outgoing side lens surface 156. The measurement light is focused toward the light receiving element 120.

The measurement light, which passes along the first optical path 157, is collimated on the incidence side reflective surface 152 at an angle of 45 degrees relative to the outer surface 210 of the windshield 200. The measurement light, which passes along the second optical path 158, is collimated on the incidence side lens surface 153 at an angle of 45 degrees relative to the outer surface 210 of the windshield 200. In other words, the lens 150 is formed to cause the light, which passes along each of the first and second optical paths 157 and 158 through the sheet 160, to be totally reflected on a raindrop detection surface of the outer surface 210 of the windshield 200 at an angle greater than or equal to a critical angle.

As described above, the first optical path 157 and the second optical path 158 differ from each other in the incidence path on the lens 150. Nevertheless, in each of the first optical path 157 and the second optical path 158, the light reflected on the outer surface 210 of the windshield 200 is focused through the outgoing side lens surface 156 toward the light receiving element 120.

Subsequently, an operation of the processing unit 130 will be described. The processing unit 130 executes light emission processing, arithmetic processing, abnormality determination processing, and control processing. The light emission processing is to cause the light emitting element 110 to serially emit pulsed light. The light emission processing is, for example, a PWM control processing to cause the light emitting element 110 to blink by using a pulse signal.

The arithmetic processing is to acquire, as a sensor output signal for each pulsed light, a difference value between a light receiving value of the light receiving element 120, which is before or after emission of the pulsed light, and a light receiving value of the light receiving element 120, which is at a time point of emission of the pulsed light (light emission time point). The abnormality determination processing is to determine whether an abnormality occurs in the sensor output signal.

The control processing is to control an operation of the vehicular wiper device 300 according to the sensor output signal processed through the abnormality determination processing. In the present embodiment, four serial sensor output signals are aggregated into one group, and the abnormality determination processing is repeatedly executed on the one group of the sensor output signals corresponding to serial pulsed light. Thus, an average value of four groups of the sensor output signals, that is, an average value of sixteen sensor output signals are acquired. As shown in FIG. 2, the average value of the sixteen sensor output signals are used for a wiper control. The average value is repeatedly acquired for the sixteen sensor output signals as one unit, and the determination for the wiper operation is made for each of the acquisitions of the average value.

Subsequently, the abnormality determination processing of the processing unit 130 will be described. In the abnormality determination processing, determination permission processing and comparison processing are mainly executed. The determination permission processing is to determine whether to permit or prohibit the comparison processing. The comparison processing is executed when being permitted through the determination permission processing.

The comparison processing is to compare a difference value, which is between a previous value of the sensor output signal and a present value of the sensor output signal, with an abnormality threshold thereby to determine whether the present value is a normal value. The comparison processing is to increment an abnormality determination count by one when the present value is determined to be an abnormality value. The comparison processing is further to reset the abnormality determination count subsequent to completion of all the abnormality determination processing on one group of the sensor output signals. The abnormality determination count may be a flag.

Specifically, on starting the abnormality determination processing, at step S170, the determination permission processing is executed. Specifically, it is determined whether the abnormality determination count is incremented on one group of the sensor output signals. When the abnormality determination count is not incremented, the comparison processing is permitted, and the processing proceeds to step S171. When the abnormality determination count is incremented, the comparison processing is prohibited, and the processing proceeds to step S175.

When the comparison processing is permitted at step S170, at subsequent step S171, the previous value of the sensor output signal is read. Subsequently, at step S172, the present value of the sensor output signal is read.

Subsequently, at step S173, it is determined whether the difference value between the previous value of the sensor output signal and the present value of the sensor output signal is greater than or equal to the abnormality threshold a. In the arithmetic processing, an absolute value of the difference value is acquired. The abnormality threshold is a magnitude of fluctuation in the sensor output signal, which could cause a malfunction (false operation) of the wiper, even in a case where averaging processing is implemented on multiple values of the sensor output signal. When the difference value is greater than or equal to the abnormality threshold, the processing proceeds to step S174. Alternatively, when the difference value is greater than or equal to the abnormality threshold, the processing proceeds to step S176.

At step S174, it is determined that the present value is a normal value. Subsequently, at step S175, the present value is read as the sensor output signal for the control processing. Step S175 is executed also when the comparison processing is prohibited at step S170.

To the contrary, in a case where the difference value is greater than or equal to the abnormality threshold at step S173, the processing proceeds to step S176 where it is determined that the present value is the abnormality value. In this case where it is determined that the present value is the abnormality value, the abnormality determination count is incremented by one. The increment of the abnormality determination count is made only once on one group of the sensor output signals.

Subsequently, at step S177, the present value, which is determined to be the abnormality value, is processed not be used for the control processing. In the present embodiment, the present value is substituted with the previous value.

At step S178, the present value, which is read at step S175, or the previous value, which is substituted at step S176, is sent for the wiper control. In this way, the abnormality determination processing is completed on one sensor output signal of one group of the sensor output signals. Subsequently, the abnormality determination count is reset subsequent to completion of all the abnormality determination processing on all the sensor output signals of the one group of the sensor output signals. The abnormality determination processing is executed repeatedly on four serial groups of the sensor output signals. Consequently, sixteen sensor output signals, which have been executed with the abnormality determination processing, are obtained.

Subsequently, in the control processing, it is determined whether the average value of the sixteen sensor output signals is greater than or equal to an operational threshold. When the average value is not greater than or equal to the operational threshold, the operation of the wiper device 300 is not performed. To the contrary, when the average value is greater than or equal to the operational threshold, the rain sensor 100 sends a control signal to the wiper device 300 to control the wiper device 300. Thus, the wiper device 300 operates the wiper according to the control signal.

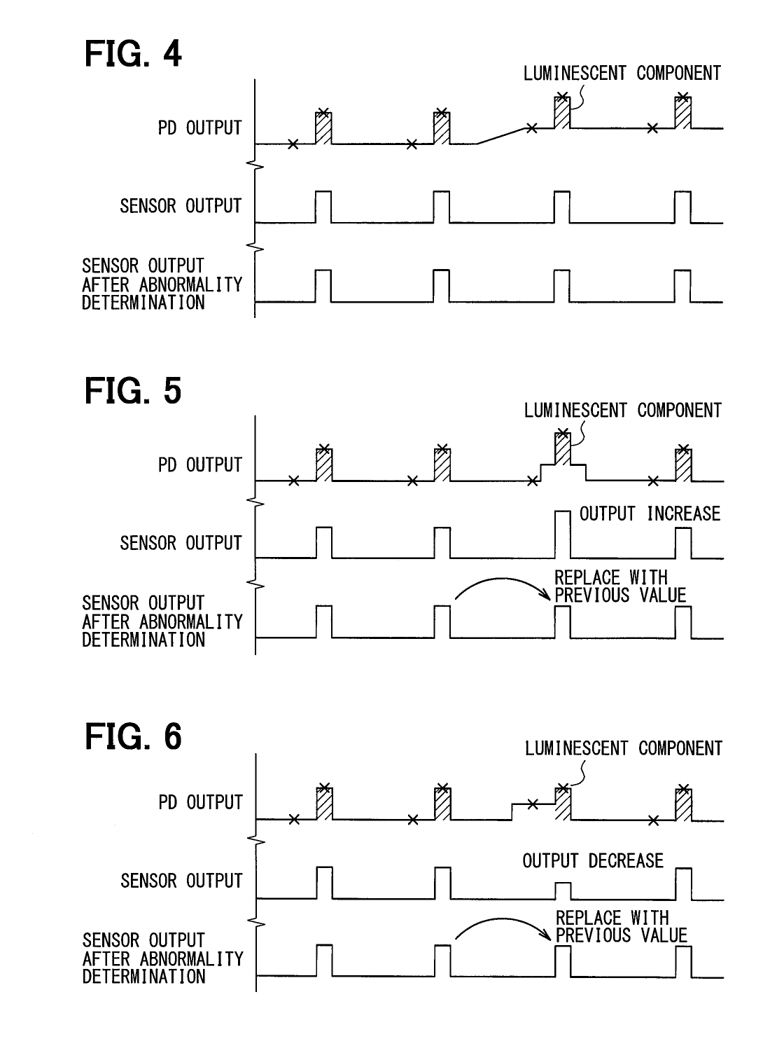

Subsequently, a detailed example of the sensor output signal will be described. In one example, as shown in FIG. 4, in a condition where significantly momentary light, such as flash of a camera, is not incident on the rain sensor 100, the sensor output signals become substantially identical to each other. In FIG. 4, the PD output represents the light receiving value of the light receiving element 120.

In this example, circumference light components of the first and second PD outputs are slightly different from circumference light components of the third and fourth PD outputs. Nevertheless, the circumference light component of each pulsed light before its light emission time point is substantially the same as the circumference light component of the pulsed light at its light emission time point. Therefore, the difference between the PD output before the light emission time point and the PD output at the light emission time point becomes the luminescent component. Thus, in the example shown in FIG. 4, the sensor output signal is not determined to be the abnormality value.

To the contrary, in a different example, an automatic scanning apparatus for a vehicular license plate emits infrared light for a short light emission time period at a constant cycle. In such a condition, light incidents on the rain sensor 100 for a short light emission time period. In such a case, as shown in FIGS. 5 and 6, for example, the third sensor output signal varies relative to the other sensor output signals.

In the example of FIG. 5, the circumference light component of the third pulsed light at its light emission time point is higher than the circumference light component of the third pulsed light before (sufficiently before) its light emission time point. Consequently, the third sensor output signal increases compared with the other sensor output signals.

In the example of FIG. 6, the circumference light component of the third pulsed light before its light emission time point is higher than the circumference light component of the third pulsed light at its light emission time point. Consequently, the third sensor output signal decreases compared with the other sensor output signals.

In the examples of FIGS. 5 and 6, the third sensor output signal is determined to be the abnormality value in the comparison processing. In response, the third sensor output signal, which is the present value, is substituted with the second sensor output signal, which is the previous value. In this way, fluctuation in the third sensor output signal is eliminated. Therefore, the average value of the sensor output signals is not determined to exceed the operational threshold in the control processing.

As described above, even in a case where light incidents on the rain sensor 100 for a significantly short time, the present value of the sensor output signal is not determined to be the abnormality value in the abnormality determination processing and is not used in the control processing. In this way, the device enables not to cause an unnecessary fluctuation in the serial sensor output signals. Thus, the device enables to restrict the wiper device 300 from causing malfunction, i.e., from performing a false operation.

It is noted that, light emitted in a significantly short time from, for example, an automatic scanning apparatus for a vehicular license plate, is single shot, i.e., is not continuous. In consideration of this, the device increments the abnormality determination count on the group of sensor output signals. That is, limitation is set to the number of the increment of the abnormality determination count. Therefore, the device steadily enables to detect fluctuation in the sensor output signal, which changes continuously, while enabling to detect fluctuation in the sensor output signal being single shot.

### Second Embodiment

In the present embodiment, difference from the first embodiment will be described. In the present embodiment, the present value is discarded at step S177 in the comparison processing. The present configuration enables to restrict fluctuation caused in the sensor output signal being single shot from being used in the averaging processing in the control processing.

### Third Embodiment

In the present embodiment, difference from the first and second embodiments will be described. In the present embodiment, at step S177 in the comparison processing, the value is substituted with the second largest one of the value before the previous value, the previous value, and the present value of the sensor output signal.

Fluctuation in the sensor output signal, which is the single shot, does not continue. Therefore, in a case where the previous value is a single-shot abnormality value, the single-shot abnormality value is a maximum value or a minimum value among the value before the previous value, the previous value, and the present value of the sensor output signal. Therefore, the present value can be substituted with a normal value, i.e., an appropriate value by selecting the second-largest value among the three values.

### Other Embodiment

The configuration of the rain sensor 100 shown in each of the embodiments is one example. The configuration of the rain sensor 100 is not limited to the above-exemplified configurations and may employ another configuration which enables to practice the present disclosure. For example, the shape of the lens 150 is one example. The lens 150 may be in another shape.

In the above-described embodiments, the determination permission processing is executed before the comparison processing in the abnormality determination processing. It is noted that, this is one example of the processing. For example, the comparison processing may be executed in the abnormality determination processing, without execution of the determination permission processing. In this case, steps S171 to S178 are executed.

It is further noted that, the processing to perform the abnormality determination on the group of the sensor output signals is also one example. In addition, the processing to average the multiple groups of the sensor output signals is also one example. That is, the above-described configuration of the four sensor output signals of the four groups is one example. The configuration may be arbitrarily modified correspondingly to a light emission cycle of an infrared light, which possibly incident to the rain sensor 100, and/or the light emission cycle of the light emitting element 110 of the rain sensor 100. The usage of how the sensor output signal is utilized for determination of the wiper operation may be determined arbitrarily.

The above-described rain sensor includes the light emitting element 110 and the light receiving element 120. The light emitting element 110 is located on the side of the inner surface 220 of the windshield 200 of the vehicle and configured to emit light toward the inner surface. The light receiving element 120 is located on the side of the inner surface and configured to receive light reflected on the outer surface 210 of the windshield.

The rain sensor includes the lens 150. The lens 150 is configured to collimate the light emitted from the light emitting element into the parallel light while guiding the light to the inside of the lens 150. The lens 150 is further configured to conduct the collimated parallel light toward the outer surface of the lens 150 and to guide the light reflected on the outer surface to the light receiving element.

The rain sensor further includes the processing unit 130 configured to execute the Light emission processing, the arithmetic processing, the abnormality determination processing, and the control processing. The Light emission processing is to cause the light emitting element to emit pulsed light serially. The arithmetic processing is to acquire, as the sensor output signal, the difference between the light receiving value of the light receiving element, which is before or after the light emission time point of the pulsed light, and the light receiving value of the light receiving element, which is at the light emission time point of the pulsed light, for each pulsed light. The abnormality determination processing is to determine whether an abnormality arises in the sensor output signal. The control processing is to control the operation of the vehicular wiper device 300 according to the sensor output signal processed with the abnormality determination processing.

The processing unit is further configured to execute the comparison processing in the abnormality determination processing. The comparison processing is to acquire the difference value between the previous value of the sensor output signal and the present value of the sensor output signal. The comparison processing is further to determine that the present value is the normal value and to use the present value as the sensor output signal when the difference value is greater than or equal to the abnormality threshold. The comparison processing is further to determine that the present value is the abnormality value and not to use the present value for the control processing when the difference value is greater than or equal to the abnormality threshold.

The present configuration does not use the present value for the control processing even in a case where momentary light is incident for a significantly short light emission time. In this way, the present configuration restricts unnecessary fluctuation from occurring in the sensor output signal. Thus, the present configuration enables to restrict the wiper device from performing a false operation in a case where momentary light is incident for a significantly short light emission time.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A rain sensor comprising:
a light emitting element configured to be located on a side of an inner surface of a windshield of a vehicle and to emit light toward the inner surface;
a light receiving element configured to be located on the side of the inner surface and to receive light reflected on an outer surface of the windshield;
a lens configured to guide light, which is emitted from the light emitting element, to its inside while collimating the light into parallel light, to conduct the collimated light to the outer surface, and to guide the light, which is reflected on the outer surface, toward the light receiving element; and
a processing unit configured to execute:
light emission processing to cause the light emitting element to serially emit pulsed light;
arithmetic processing to acquire, as a sensor output signal for the pulsed light, a difference between a light receiving value of the light receiving element, which is before or after a light emission time point of the pulsed light, and a light receiving value of the light receiving element at the light emission time point of the pulsed light;
abnormality determination processing to determine whether an abnormality arises in the sensor output signal; and
control processing to control an operation of a wiper device of the vehicle according to the sensor output signal processed with the abnormality determination processing, wherein
the processing unit is configured to execute, in the abnormality determination processing, comparison processing:
to acquire a difference value between a previous value of the sensor output signal and a present value of the sensor output signal;
to determine that the present value is a normal value and to use the present value as the sensor output signal when the difference value is less than an abnormality threshold; and
to determine that the present value is an abnormality value and not to use the present value for the control processing when the difference value is greater than or equal to the abnormality threshold.

2. The rain sensor according to claim 1, wherein
the processing unit is configured to, in the comparison processing, substitute the present value with the previous value when the difference value is greater than or equal to the abnormality threshold.

3. The rain sensor according to claim 1, wherein
the processing unit is configured to, in the comparison processing, discard the present value when the difference value is greater than or equal to the abnormality threshold.

4. The rain sensor according to claim 1, wherein
the processing unit is configured to, in the comparison processing, substitute the present value with second largest one of a value before the previous value, the previous value, and the present value when the difference value is greater than or equal to the abnormality threshold.

5. The rain sensor according to claim 1, wherein
the processing unit is configured to execute, when repeating the abnormality determination processing on a group of sensor output signals caused by serial pulsed light, determination permission processing:
to increment an abnormality determination count by one when determining that the present value is the abnormality value in the comparison processing;
to reset the abnormality determination count subsequent to completion of all the abnormality determination processing on the group of sensor output signals;
to permit the comparison processing when the abnormality determination count is not incremented before the comparison processing; and
to prohibit the comparison processing and to use the present value as the sensor output signal when the abnormality determination count is incremented before the comparison processing.

6. The rain sensor according to claim 5, wherein
the processing unit is configured:
to execute the abnormality determination processing on a plurality of groups of serial sensor output signals; and
to operate the wiper device when an average value of the plurality of groups of serial sensor output signals is greater than or equal to an operational threshold in the control processing.
